(19) United States
(12) Patent Application Publication
(10) Pub. No.: US 2004/0179730 A1
(43) Pub. Date: Sep. 16, 2004

(54) Paper white determination

(75) Inventor: Ching-Wei Chang, Vancouver, WA (US)

Correspondence Address: Robert D. Varitz, ROBERT D. VARITZ, P.C., 2007 S.E. Grant Street, Portland, OR, 97214, US

(73) Assignee: Sharp Laboratories of America, Inc.

(21) Appl. No.: 10/387,665

(22) Filed: Mar. 12, 2003

(51) Int. Cl. G06K 9/00

(52) U.S. Cl. 382/162; 382/168

(57) ABSTRACT

Determination from color-page-scan data, and from per-color-channel histogramic representations of that data, what range of pixel-color values, if any, should all be declared to be “determined” paper white values.

This invention generally relates to paper white determination, and very specifically to a method for determining dynamically RGB color-channel values that correspond to the relative white values in these color channels for a selected scanned document.

Low-end desktop scanners typically have fewer and less robust color calibration features than do more expensive scanners that are commonly used in the professional printing and publication industry. A problem that often occurs with respect to documents that are scanned by such scanners, especially with respect to what may be thought of as color documents, is that such a scanner is unable accurately to distinguish the real color of the paper employed in the document, typically some value of the color white. Very specifically, this inability to distinguish the true “paper white” color of document paper results in a poor distinction existing between true paper color and closely similar light colors that may be employed in an image that resides on the paper.

Additionally, such a low-end scanner is often unable to distinguish variations in the “whiteness” or hue of various white papers, and it is well recognized that the hue of white paper may vary considerably depending upon the paper manufacture, quality, weight, specific ingredient content, etc.

This shortcoming of so-called low-end scanners can result, and often does result, in an outcome of a scanning operation performed regarding a color image disposed on paper that produces a paper-color value, alongside a color image, which in fact is some ultimately perceived color that is decidedly not seen as a white color at all.

Various prior art systems have attempted to remedy this situation by setting some established threshold for the RGB white values representing white pixels on a page in the image appearing on that page. For example, pure white may be represented as an RGB value of 255. When this value is mapped to the CMYK color space, this RGB value of 255 corresponds to the “absence” of a dot of colored ink. However, to accommodate varying colors in the so-called “paper white” realm, a threshold range, for example, of perhaps 245-255 may be set as a thresholding range, within which, any pixels possessing such values will be mapped automatically to white.

While this approach can make some improvement in the rendering of the appearance of “paper white” in a scanned and later transmitted and printed document, an important shortcoming is that, if the established range is set too broadly, there will be areas in the color image which should correspond to a color other than white which are nonetheless erroneously mapped to white. Correspondingly, area in the image that should be mapped to white may nonetheless be mapped to a distinct color other than white. Other shortcomings also exist and are known and recognized by those generally skilled in this art.

Still another prior art technique which has been designed to remedy the so-called “paper white” problem involves the practice of distinguishing what is seen as the “paper white” area of a printed document from the image per se. For example a pre-scan of a printed document page, and specifically of the image which is printed on that page, may be made close to the border of the edge of the paper on which the image was printed. If most of the pixels in this area have very light densities, it is assumed that the values of these pixels represent a true “paper white” value. While this prior art technique does enjoy some success, when the document page and the image being scanned do not contain large white areas, this approach does not work particularly effectively.

Thus, there is clearly a need in this setting for improvement in techniques that accurately determine “paper white” paper-color values, and particularly a technique which can easily be implemented in a wide range of scanners, including those which fit into the category referred to hereinabove as low-end scanners. The present invention directly addresses this issue in a very simple and very effective manner which performs an examination of paper white values based upon histogramic information derived from a document scan procedure, with this histogramic information than utilized, on a color-channel-by-color-channel, basis to establish a meaningful threshold range for the declaration of certain pixel values as being true “paper white” values.

Various features and advantages that are offered and attained by the present invention will become more fully apparent as the description which now follows is read in conjunction with the accompanying several drawing figures.

### DESCRIPTION OF THE DRAWINGS

FIG. 1 is a block/schematic diagram illustrating, and appropriately labeled to describe, the general flow of practice of the present invention.

FIGS. 2, 3, and 4 are graphical representations presented on a single-color-channel basis to illustrate histogramic information with respect to a selected color channel, and particularly to show how this histogramic information is employed, in accordance with the invention, as a precursor to establishing an appropriate range of “paper white” thresholding values.

FIG. 5 illustrates how numeric “paper white” thresholding values are confirmedly established for printing after scanning of an image on a document reviewed for paper whiteness in accordance with practice of this invention.

### DETAILED DESCRIPTION OF THE INVENTION

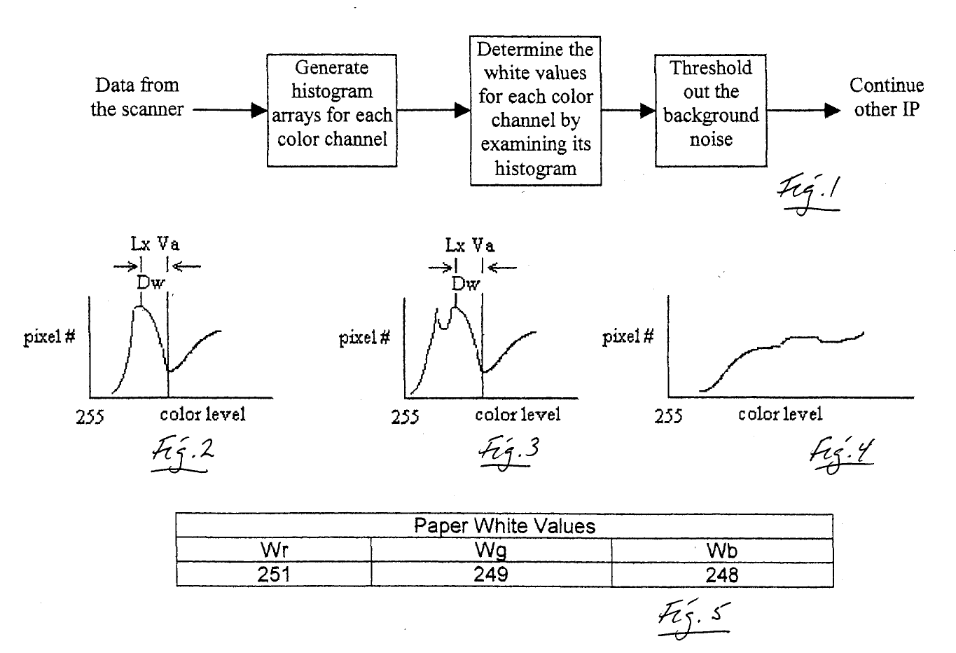

Turning now to the drawings, and referring first of all to FIG. 1, this figure describes the structural and functional architecture for implementation of the present invention. Speaking from a methodologic point of view, a document page, with respect to which a paper white value is to be determined, is scanned, and data from that scanning operation is employed, for each of the three RGB color channels, to generate a histogram array which plots the number of pixels on a vertical axis relative to pixel-color-value which is plotted on a horizontal axis. FIGS. 2, 3, and 4 show three such per-channel histogram arrays. As will shortly be explained, from the histogramic array generated for each color channel, one next determines the white values that are appropriate for each color channel by examining a peak region in the histogram array which is, located toward the left end of each histogramic array as such an array is pictured and shown in FIGS. 2, 3, and 4. If there is no distinct paper white value, as for example in an allover kind of image on a page, then there will typically not be any distinctive paper white value detected in the color channel histograms, and FIG. 4 generally illustrates this histogramic condition.

Assuming detection of an appropriate peak value, an offset is performed relative to this value to account for particular functional characteristics of the scanner involved, and very specifically to account for a white-value distribution constant, referred to as D_{w}. The offset is performed by subtracting D_{w} from the detected peak-value number in order to set the stage for appropriate per-color-channel paper white thresholding (range-setting) for pixels that will be declared to be white pixels.

With this activity performed, and a thresholding range established in each color channel, all pixels which fall within that range in each channel will be declared to be white pixels, and scan data will be appropriately “corrected” so as to declare those pixel values as being white pixel values for subsequent data processing, printing, etc.

Looking now at FIGS. 2-5, inclusive, what is here illustrated is the observation and treatment of histogramic data on a per-channel basis. In other words, what will now be specifically described relates directly to a single color channel, with the understanding that the same consideration, according to the invention, is given to each of the three RGB color channels.

A histogramic array is generate and is then observed, utilizing any appropriate data-observation algorithm which is not part of the present invention, to detect the presence of a distinct paper white value peak, such as the single peak shown in FIG. 2, and what turns out to be the right hand one of two peaks shown in FIG. 3. Where there is a very distinctive single peak value, and this is determined by the mentioned algorithm which basically looks at pixel count levels progressing to the right in the histogramic array from the detected peak value, what the algorithmic approach looks for is a distinctive valley, where the stretch of the histogramic curve which resides between the detected peak and the detected valley is characterized by a continual and non-reversed decline in pixel count progressing from the peak to the valley. Such a continual and non-reversing decline is clearly shown in FIG. 2. In FIG. 3, the algorithm will reject the left hand peak in this figure because of the fact that, progressing to the right in the pictured histogram from this first peak there is only a modest decline to a very subtle valley, and immediately thereafter there is a rise to another peak. Accordingly, the first peak is rejected as a detected paper white value, but, as can be seen in what is shown in FIG. 3, the second peak encountered is followed by a non-reversing decline in pixel count progressing to the right in this histogramic array toward the same kind of distinctive valley that is pictured in FIG. 2, and this second peak is correctly determinable to be scan-detected paper white value.

The color values of the pixels which define such confirmed and determined paper white peaks in each color channel is selected initially and placed, so-to speak in a table of values, like that table of values shown in FIG. 5. In FIG. 5, from a determination made in accordance with examination of histogramic data, the pixel white peak value, determined for the red channel is shown as possessing the number 251, that for the green channel is shown as possessing the number 249, and that for the blue channel is shown as possessing number 248.

With respect then to these determined peak values, such as those presented in the table of FIG. 5, effectively each of these numbers is reduced by the value of D_{w}, which typically is about 5, to arrive at a number which will define a thresholding range within which all pixel values will be declared to be pure white pixels. Applying the number 5 for D_{w}, there then takes place a subtraction of this number from the detected peak value numbers shown in FIG. 5. Accordingly, the “corrected” paper white value for pixels in the red channel will lie in the range from 255 in color value to 246, that for the green channel will lie in the range from 255 to 244, and those pixels in the blue channel will lie in the range from 255 to 243. All of these color-channel-specific range values will be declared to be pure white pixels in their respective channels. Accordingly, each channel is treated independently to obtain the purest and most accurate treatment of paper white rendering based upon scanned data in accordance with practice of this invention.

If histogramic information in a channel has an appearance like that shown in FIG. 4, where there is no distinctive white-value peak followed by a distinctive valley as was described earlier herein, then no paper white pixel thresholding (range-setting) takes place for pixels in that channel.

Accordingly, a very simple and very effective and quite accurate, per-color-channel method for detecting and dealing with paper white values is disclosed herein, and is offered by practice of the present invention. Those skilled in the art may determine that there are certain variations and modifications which may be made that fundamentally employ the features of this invention, and all such variation and modifications are deemed to be within the scope of this invention.

I claim:

1. A method for conducting a paper-white determination derived from full-color page-scan data produced by a scanner from a paper page comprising
acquiring such scan data,
generating, for each color channel, a histogram array,
examining the generated histogram array for each color channel, and
after performing said examining step, determining the range of pixel-color values, all of which values in that range will be declared to be paper-white values for the page from which the scan data was acquired.

2. The method of claim 1, wherein, following the range-determining step, and before the occurrence of any further processing of the acquired scan data, all pixel-color values that reside within that range are declared to be paper-white values for the subject page.

3. The method of claim 1, wherein said examining and determining steps for each color channel are conducted by looking, adjacent the white-value side of the associated histogram, for the highest peak pixel-count, and the lowest valley pixel-count, values which are connected by a portion of the histogram wherein there is a non-reversing decline seen in pixel count levels progressing in the histogram from that peak to that valley.

4. The method of claim 3 wherein, under circumstances where such connected peak and valley values are not found, there is no specific determination made to establish a thresholding range of paper-white pixel values.
